(19) United States
(12) Patent Application Publication
(10) Pub. No.: US 2024/0114336 A1
(43) Pub. Date: Apr. 4, 2024

(54) ASSET MANAGEMENT AND COMMUNICATION SYSTEM FOR LUMINAIRE DEVICES

(71) Applicant: ABL IP Holding, LLC, Conyers, GA (US)

(72) Inventors: Robert W. HAMLIN, Monroe, CT (US); Rohan Patil, Atlanta, GA (US); Che Chung Ko, Johns Creek, GA (US); Philip S. Gross, Berlin, CT (US)

(21) Appl. No.: 18/373,885

(22) Filed: Sep. 27, 2023

Related U.S. Application Data
(60) Provisional application No. 63/377,792, filed on Sep. 30, 2022.
(60) Provisional application No. 63/377,789, filed on Sep. 30, 2022.

(51) Int. Cl. H04W 12/041; H04L 9/32

(52) U.S. Cl. CPC H04W 12/041; H04L 9/3213

(57) ABSTRACT

In an approach to networking devices using an ephemeral mesh network, the system includes: a plurality of devices, each device of the plurality of devices further comprising a wireless interface to communicate with a mobile device; and a controller. The controller includes circuitry configured to connect to the mobile device; authenticate the mobile device; responsive to authenticating the mobile device, establishing a mesh network of the plurality of devices, wherein each light device connects to at least one other devices of the plurality of devices to create a mesh network; and responsive to disconnecting from the mobile device, dissolving the mesh network by disconnecting each device from the plurality of devices.

### CROSS REFERENCE TO RELATED APPLICATIONS

This application claims priority to U.S. Provisional Application 63/377,789, filed 30 Sep. 2022; and this application claims priority to U.S. Provisional Application 63/377,792 filed 30 Sep. 2022, both of which are incorporated herein by reference in their entirety.

### TECHNICAL FIELD

The present application generally relates to asset management and communications for luminaire devices.

### BRIEF DESCRIPTION OF THE DRAWINGS

Reference should be made to the following detailed description which should be read in conjunction with the following figures, wherein like numerals represent like parts.

FIG. 1 illustrates an asset management and communication system for luminaire devices according to embodiments of the present disclosure;

FIG. 2 illustrates an example luminaire device according to one embodiment of the present disclosure;

FIG. 3 illustrates a block diagram example of detailed interactions between the server system, a plurality of remote devices and the mobile device according to one example embodiment of the present disclosure;

FIG. 4 illustrates a block diagram of a software system associated with the server system, in accordance with an embodiment of the present disclosure;

FIG. 5 illustrates an example of a hierarchical structure of the database associated with the server system, in accordance with an embodiment of the present disclosure;

FIG. 6 illustrates another example of a hierarchical structure of the database associated with the server system in accordance with an embodiment of the present disclosure;

FIG. 7 illustrates another example of a hierarchical structure of the database associated with the server system, in accordance with an embodiment of the present disclosure;

FIG. 8 illustrates an example of roles and permissions in the system, generally designated, in accordance with an embodiment of the present disclosure;

FIG. 9 illustrates an example of a mesh network of lighting devices, generally designated, in accordance with an embodiment of the present disclosure;

FIG. 10A illustrates an example of a typical PAN, in accordance with an embodiment of the present disclosure;

FIG. 10B illustrates an example of a mesh network, in accordance with an embodiment of the present disclosure; and

FIG. 10C illustrates an example of an ephemeral mesh network, in accordance with an embodiment of the present disclosure.

### DETAILED DESCRIPTION

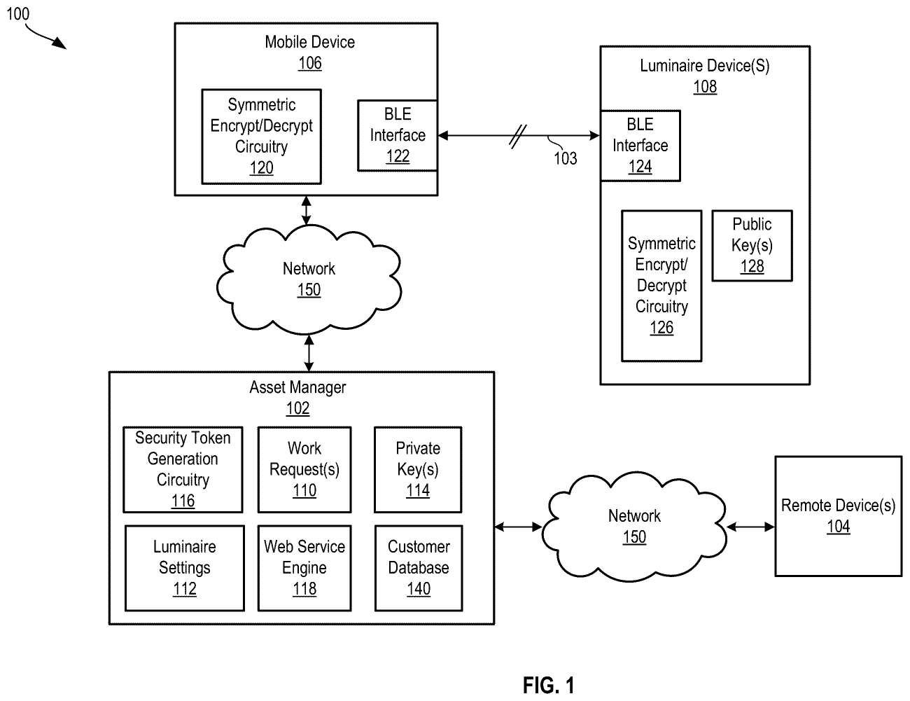

FIG. 1 illustrates an asset management and communication system 100 for luminaire devices according to embodiments of the present disclosure. The system 100 includes an asset management server system 102 generally configured to communicate with a plurality of remote device(s) 104, via network 150. The remote device(s) 104 may include “backend devices”, for example, customers, field personnel, asset managers, etc., as will be described below. The server system 102 is also configured to communicate with one or more mobile device(s) 106. The mobile device 106 is configured to communicate with one or more luminaire devices 108, via network 150. The mobile device 106 may include any known or after-developed mobile computing system such as, for example iOS-based devices (e.g., iPad, iPhone, Macbook, etc.) and/or Android-based devices (e.g., Galaxy, etc.) and/or any other mobile device that is generally configured to communicate using known or after-developed communications protocols such as Wifi, Bluetooth, etc. The luminaire device(s) 108 may include, for example, municipal lighting fixtures, roadway lighting fixtures, commercial lighting fixtures, etc. For cost and safety reasons, the luminaire devices 108 are generally configured to include short-range wireless communication ability (e.g., Bluetooth, BLE, etc.) but do not include long range wireless communications abilities (e.g., WiFi, cellular, etc.) so that the luminaire devices 108 can only communicate with, and be controlled by, the one or more mobile devices 106 within a short operating range.

The server system 102 is generally configured to enable a secure communications link between the server system 102 and the one or more mobile devices 106, and between the one or more mobile devices 106 and the one or more luminaire devices 108. The server system 102 may include storage media to host a plurality of data. As a general matter, and as will be described in greater detail below, the server system 102 is configured to communicate with a plurality of devices to provide a coherent end-to-end management of luminaire devices, for example, from customer ordering, specific requirements and operational characteristics of luminaire devices, organizational management and control of luminaire devices, etc. For example, the server system 102 may store work request data 110, as may be generated by asset managers/owners of the one or more luminaire devices 108. The server system 102 may also store setting data 112, which may pertain to one or more luminaire device(s) 108, as will be described below.

The server system 102 may also store one or more private encryption keys 114 to enable asymmetric encrypted communication with one or more luminaire devices 108, using public key(s) 128 stored on the luminaire devices 108. The private key(s) 114/public keys 128 may be provisioned on an organizational hierarchy, e.g., encrypted communication to luminaire devices 108 may be restricted to an organization that owns and/or controls the luminaire(s) 108. The server system may also include security token generation circuitry 116 to generate a security token to authorize communication between a mobile device 106 and the luminaire devices 108. The security token may include an encrypted portion and an unencrypted portion. The unencrypted portion may include a random number and a date stamp, and the encrypted portion may include an encrypted version of the unencrypted portion using the private key 114. As will be described below, the mobile device 106 is configured to securely communicate with the luminaire devices 108 using, for example, symmetric encryption/decryption circuitry 120/126 in the mobile device 106 and the luminaire device(s) 108, respectively. The communications link 103 between the mobile device 106 and a luminaire device 108 may comply with a Bluetooth communications protocol.

The server system 102 may also include a web service engine 118 to enable the one or more remote devices 104 to communicate with the server 102 and to control one or more luminaire devices 108, via the mobile device 106 (described below). While the mobile device 106 is connected to one or more luminaire devices 108, the mobile device 106 provides a conduit for the server system 102 to interact with luminaires 108.

The mobile device 106 is generally configured to provide the means for authenticated users to form a point-to-point PAN connection, e.g., BLE, with the luminaires 108, for the purpose of manually controlling the light output, adjusting settings, and collecting status. The mobile device 106 also provides access to the server system 102 so that mobile users can be authenticated, receive security tokens that allow connections to luminaires, and also to browse and retrieve data stored on the server 102.

Additionally, the mobile device 106 is configured to enable the luminaire 108 to synchronize its data with the server 102. Settings can be edited in the web application, either using an application on the mobile device 106 and/or from one or more remote devices 104, and such settings are communicated to the luminaire 108 using the mobile device 106 as a data pipe. Similarly, whenever the mobile device 106 connects to a luminaire 108, current settings and status in the luminaire 108 are transferred to the mobile device 106 and uploaded to the server 102 whenever internet connectivity is available.

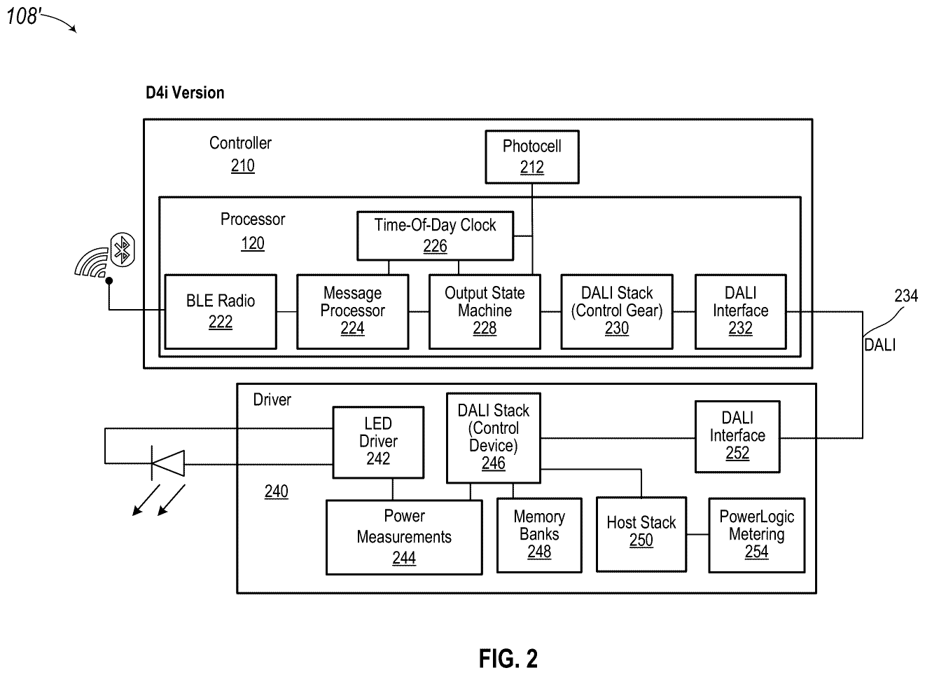

FIG. 2 illustrates an example luminaire device 108′ according to one embodiment of the present disclosure. The luminaire device 108′ of this embodiment may include the functionality of the luminaire device 108 described above, and also include the following features. In this embodiment, the luminaire device 108′ complies with a D4i standard of the DALI (Digital Illumination Interface Alliance) standard for intelligent, Internet of Things (IoT)-ready luminaires. In the example of FIG. 2, controller 210 includes photocell 212 and processor 220. Processor2120 includes Bluetooth Low Energy (BLE) radio 222, message processor 224, time-of-day clock 226, output state machine 228, DALI stack 230, and DALI interface 232. Controller 210 is communicatively coupled to driver 240 via the DALI interface 234. Driver 240 includes the LED driver 242, power measurements 244, DALI stack 246, memory banks 248, generic host stack 250, DALI interface 252, and PowerLogic metering 254.

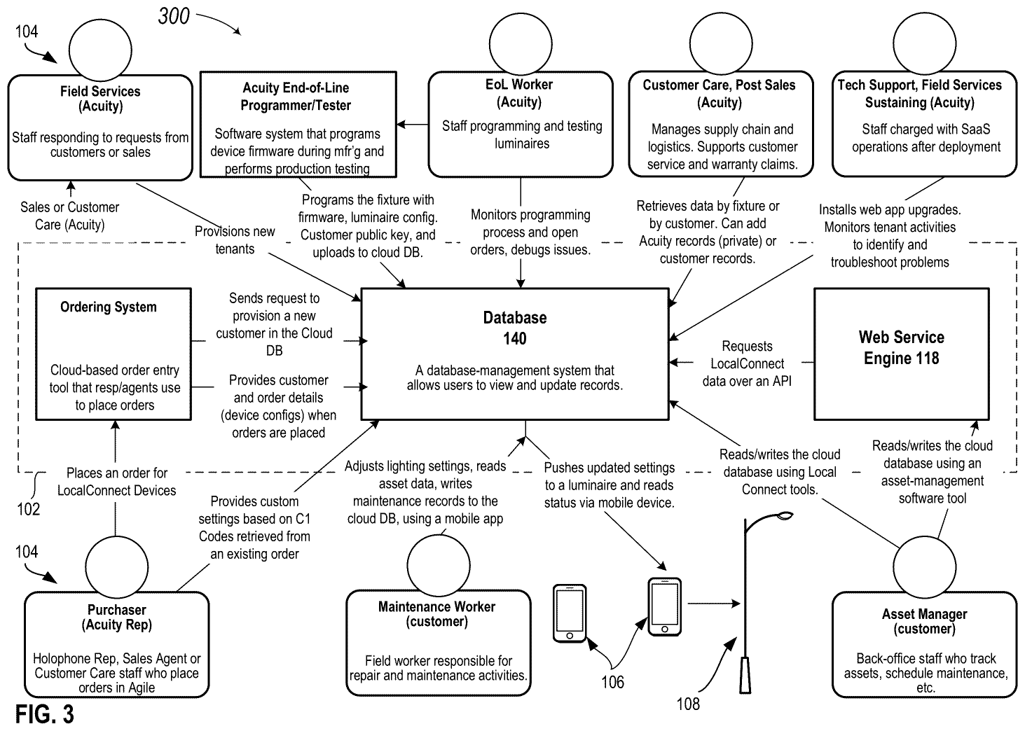

FIG. 3 illustrates a block diagram 300 example of detailed interactions between the server system 102, a plurality of remote devices 104 and the mobile device 106 according to one example embodiment of the present disclosure. In general, the block diagram 300 of FIG. 3 describes various functionality that may be attributed to the remote devices 104 and illustrates how such functionality interacts with the server system 102. In the example of FIG. 3, customer personas (remote devices 104) are shown in the bottom row, middle and right. The server system 102 is primarily an asset management service for use by customers. In one example, asset management lifecycle begins when an order is placed and the device is manufactured, and such data may be stored on the server system 102. The web services engine 118 of the server system 102 is generally configured to interface with several software systems used in the ordering and manufacturing processes, in order to collect asset management data during those steps, and also to load customer-specific (“Organizations”) data into the luminaires 108.

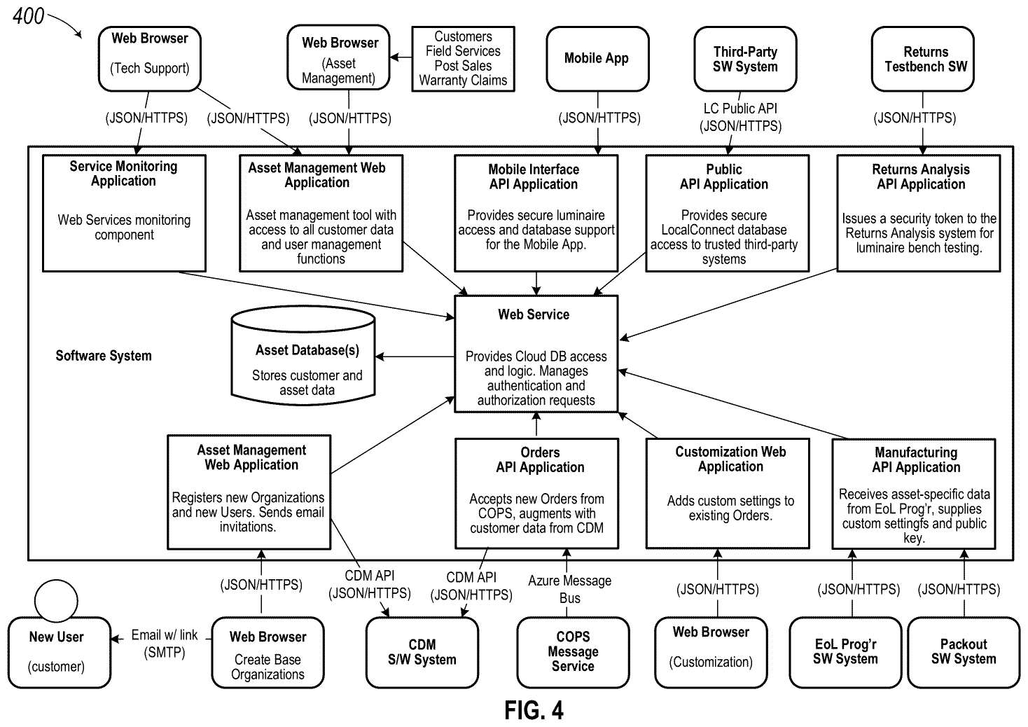

FIG. 4 illustrates a block diagram 400 of a software system associated with the server system 102, in accordance with an embodiment of the present disclosure. The functional diagram is meant to be a conceptual illustration of how the software system is organized and to provide a vehicle for organizing functional requirements of the server system 102. The functional diagram is organized as a collection of interfaces all calling on the server system 102, which provides backend logic and access to the database 140. User interfaces are shown as Web Applications which together with an external web browser, thus illustrating a model-view-controller pattern. The view is executed in the web browser which acts as the client making API calls over HTTPS. The Web Application module provides the data model and controller (logic) functionality while keeping its data model coherent with the central database 140. The server system 102 also has data model responsibilities, for example, when data updates are received from an interface, updates are made to certain state and status fields, and stores historical records.

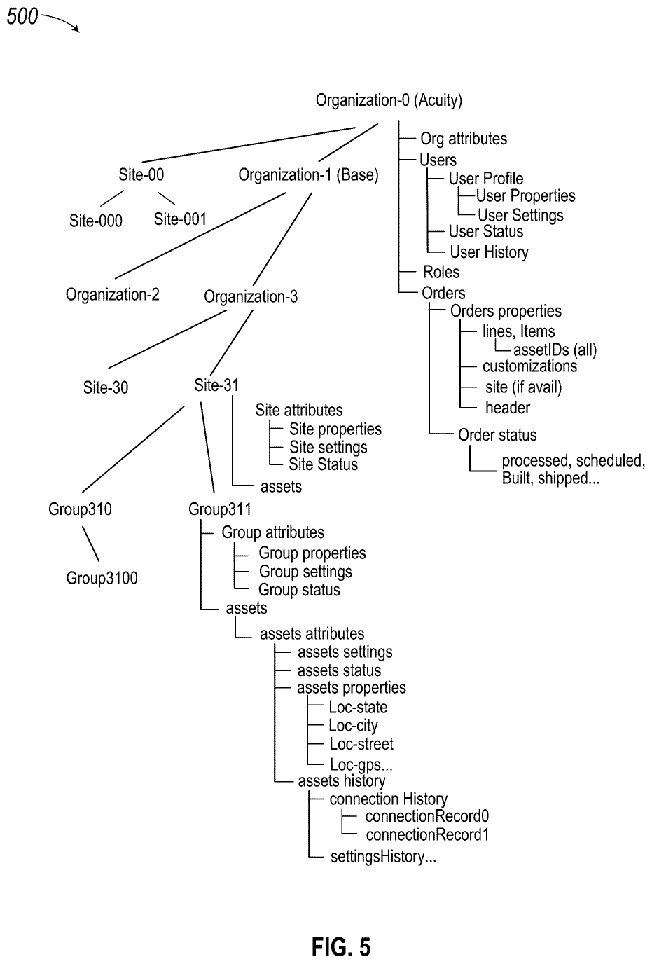

FIG. 5 illustrates an example of a hierarchical structure 500 of the database 140 associated with the server system 102, in accordance with an embodiment of the present disclosure. This figure illustrates an example of how data is stored and managed on the system database. The database is arranged in a tree hierarchy of Organizations. In the example system database of FIG. 5, the Acuity Brands Organization is the root node. Organizations may have any number of children, but a child Organization can have only one parent. Organizations with Acuity as the parent are Base Organizations.

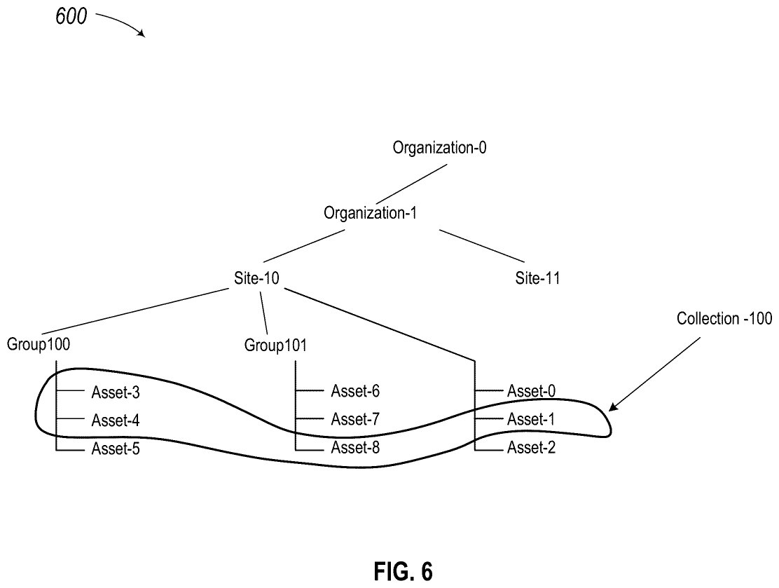

FIG. 6 illustrates another example of a hierarchical structure 600 of the database 140 associated with the server system 102, in accordance with an embodiment of the present disclosure. In this example, collections of asset groupings of the system, for example “Collection-100”, are generally depicted as being orthogonal to the tree hierarchy. Collections can store any Asset in an Organization, from any Site or Group in the Organization. Assets can be a member of multiple Collections simultaneously. Collections can be named and have an associated User-supplied description, and collections are created by Users in the Organization.

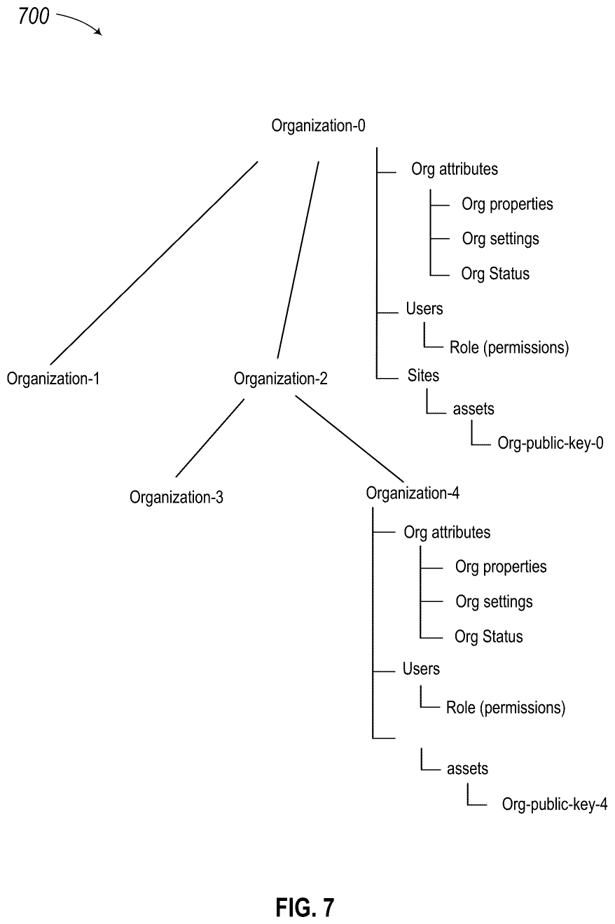

FIG. 7 illustrates another example of a hierarchical structure 700 of the database 140 associated with the server system 102, in accordance with an embodiment of the present disclosure. In particular, this embodiment illustrates the system security hierarchy, generally designated 700, in accordance with an embodiment of the present disclosure. In addition to forming the basis of the data hierarchy, Organizations are also used to form the security hierarchy. Organizations are actually Owner/Manager-Organizations, meaning they identify groups of users that own and/or manage a group of luminaires that are stored as assets in the database and can be accessed directly using the mobile device 106. Typically, Users in parent Organizations have access to the luminaires and cloud data owned by their children and grandchildren, all the way down the hierarchy, although this can be changed through permissions. However, child Organizations do not have access to the assets of their parents or their siblings. Therefore, for secure access, luminaires store the org-public-key associated with their immediate owner. When Users login, they are issued security tokens for the Organizations they have access to.

In the example diagram of FIG. 7, notice the two different org-public-keys. If a user in Organization-4 logs in, only a security token corresponding to that Organization is issued, so access will be granted only to luminaires storing org-public-key-4. Critically, that user will not be able to access luminaires storing any other public keys. On the other hand, when a user in Organization-0 logs in, that user is issued security tokens for every Organization shown in the diagram, which is to say, Organization-0 and every Organization below it. Luminaires advertise their organization-id so the mobile device knows which token to present when challenged, thus users can access all luminaires in their Organization and below.

The org-public-key-4 stored in the luminaire is written during manufacturing and will always be associated with the lowest leaf in the hierarchy known at the time of programming. If additional child Organizations are created later, or if ownership needs to transfer to an Organization lower in the hierarchy, assets will need to be moved and the org-public-key will need to be replaced using the key update procedure. Users are only a member of one Organization, as indicated by userMemberOrg stored with the User. They have access to additional Organizations listed in their userOrgAccess list.

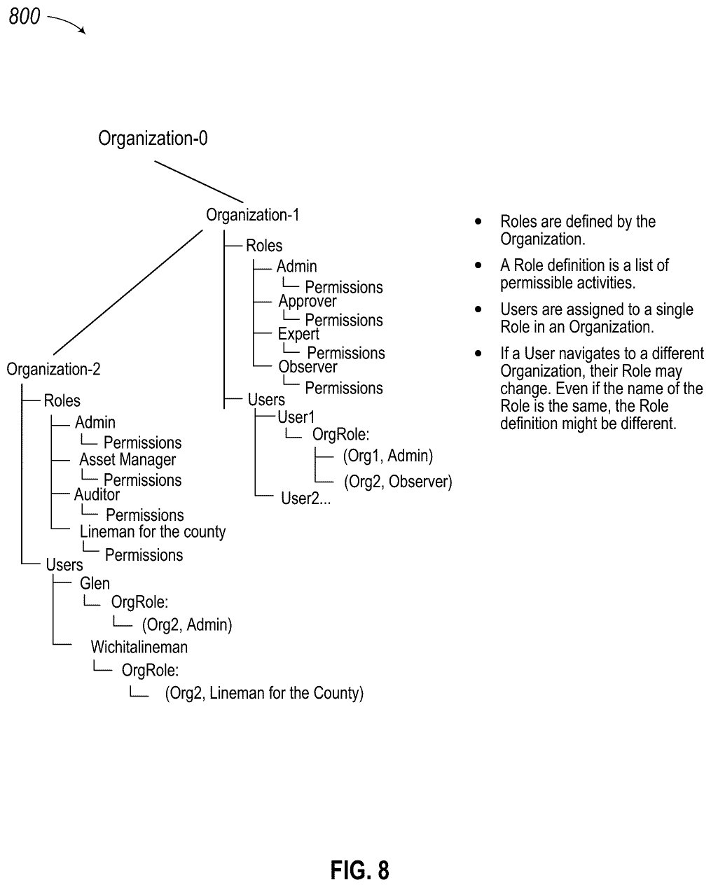

FIG. 8 illustrates an example of roles and permissions in the system, generally designated 800, in accordance with an embodiment of the present disclosure. Roles are stored as part of an Organization and are used to define permissible activities for each User. Users do not each have a collection of permissible activities, instead they are assigned to a Role. Users can have a different Role in each Organization they have access to. A Role is list of permissible activities in the system. Activities are categorized as follows: Manage—approve, create, delete, or move; Edit—edit the properties and settings associated with the item; View—view the item; and Restore—view and restore removed items. Roles always describe permissible activities in the current Organization and do not refer at all to parent or child Organizations. The one exception is for managing Organizations/Sites, which refers to approving, creating, or deleting a direct child Organization/Site (it makes no sense to approve, create, or delete an Organization you are currently in).

For each organization registered in the system, a key-pair is generated; the private-key is stored only in the server 102, and a copy of the public-key is stored in each of the luminaire devices 108 during manufacturing by the manufacture of the luminaire devices. When an order is placed, information about the order, which includes the associated organization, is passed to the manufacturing system. Manufacturing sends a message to the asset management platform with the serial number of the asset and the asset management platform responds with settings data and the proper public-key. When mobile devices 106 log in to the server 102, they are issued a security token that was generated by the server 102. The token includes a nonce (a random number combined with some other information), and an encrypted version of the nonce that is encrypted with the private key. Immediately after a wireless connection is formed between the mobile device 106 and the luminaire device 108, the mobile device 106 sends the security token to the device 108. The encrypted data can only be decrypted using the proper public-key, so if it matches the included nonce, the device 108 knows the user is a member of the same organization. If the security token is not sent or cannot be decrypted successfully, the device 108 terminates the connection.

This disclosure also provides a system and method to emulate many of the benefits of networked systems but without requiring a network. With continued reference to FIG. 1, a cloud-based web service performs asset management, allows users to edit settings that will be pushed to devices and stores the latest data retrieved from the devices. Mobile devices running an application-specific app are used to wirelessly connect to the devices to push settings from the cloud and retrieve status. While the app can be used to manually control the devices, its primary purpose is to serve as a data pipe between the devices and the cloud.

FIG. 1 illustrates an example system, generally designated 100, for a point-to-point wireless communications link between a mobile device 106 and a lighting device 108, in accordance with an embodiment of the present disclosure. The example system shown in FIG. 1 allows for a point-to-point wireless communications link between a mobile device 106 and a lighting device 108 equipped with an onboard microprocessor-based controller that includes an integrated BLE radio transceiver (as illustrated in FIG. 2). While the example of FIG. 1 illustrates a mobile device connected to a lighting device over a BLE connection, any PAN could be used in place of BLE as would be known to a person of skill in the art. The mobile device 106 may include a mobile application (e.g., an application-specific software program running on the mobile device operating system) that allows the user to enter commands, thus controlling the behavior of the device.

The luminaire device 108 stores settings that effect the behavior of the device. Using the example of a streetlight, for on/off behavior that is based on outdoor light levels, the device 108 stores the corresponding light thresholds. The device 108 also stores a lighting schedule that adjusts the brightness of the device based on astronomical times of day like dusk and dawn or based on the time of day it maintains with a running clock. The control points for the schedule are stored as settings in the device 108.

The system 100 of FIG. 1 is configured for emulating a network using non-networked devices, in accordance with an embodiment of the present disclosure. Functionality of the disclosed system is centered on asset management capabilities. In the typical case where the non-networked devices are streetlights, functionality includes organizing large number of assets by arranging them into groups; filtering, sorting, searching, and reporting functions; storage and display of the entire lifecycle of all assets, beginning when an order is placed; tracking the current state of all assets, including current settings values and latest energy and diagnostic data; and easily creating new settings values and installing them in target assets.

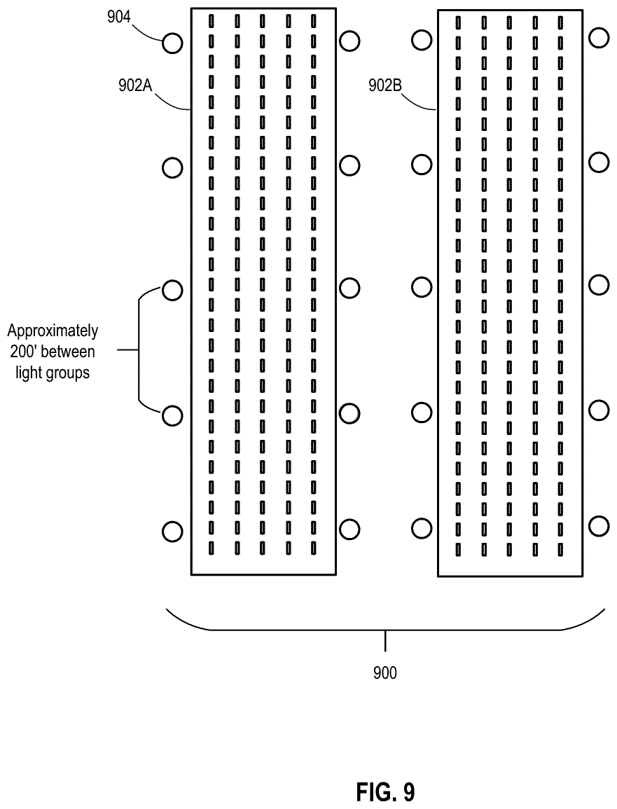

FIG. 9 illustrates an example of a mesh network of lighting devices, generally designated 900, in accordance with an embodiment of the present disclosure. In the example illustrated in FIG. 9, a bridge consists of bridge deck 902A and bridge deck 902B, each deck having a series of devices 904 on each side of the bridge deck. As noted in FIG. 9, each group of light devices spanning both bridge deck 902A and bridge deck 902B are approximately two hundred feet apart. In the example of FIG. 9, although only five groups of four devices are shown, the actual bridge is 4,735 feet long, with 25 rows of 4 lights each, or 100 total lights. In other examples, any number of devices could be supported within the limits of the underlying technology (e.g., BLE is limited to 32,767 nodes and 127 maximum hops). In some embodiments, the disclosed system may use multiple networks, using a network-to-network bridge to exceed the maximum node limitation, or for other convenience reasons, such as easier management of each sub-network due to the smaller number of nodes.

In the example of FIG. 9, the devices 904 are all interconnected using a mesh network. As described above, a mesh network is a communications network topology in which there are at least two pathways to each node, except the outermost edge nodes will typically have only one pathway. Since communications messages are passed between nodes, a mesh network can span a distance much greater than the maximum range allowed by the underlying networking topology. For example, if the underlying technology is BLE, the range is typically between 315-440 feet with a sensitivity of −92 decibel milliwatts (dBm), or 845-1185 feet with a sensitivity of −107 dBm. Since the example bridge of FIG. 9, at 4,735 feet long, exceeds the range of BLE, the use of BLE would be impossible without the use of the mesh topology.

In a standard mesh network as described above, when the computing device disconnects, the mesh remains active, security keys used to encrypt mesh communications remain valid and are stored in every node, and all messages continue to be repeated and are received by every node. This represents a security risk since an attacker that can communicate with a single node can now control the entire mesh. To address security concerns, disclosed herein is a method of establishing an ephemeral mesh network for control sessions, then automatically tearing down the mesh once the session is complete.

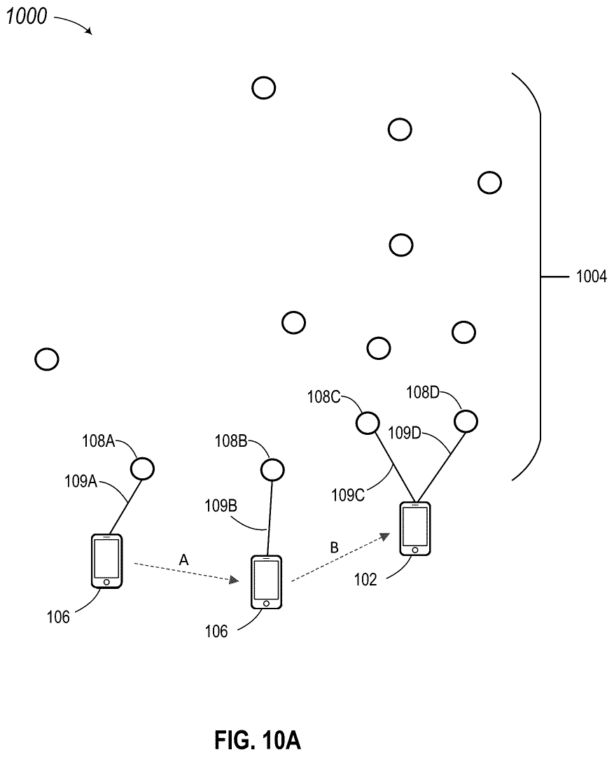

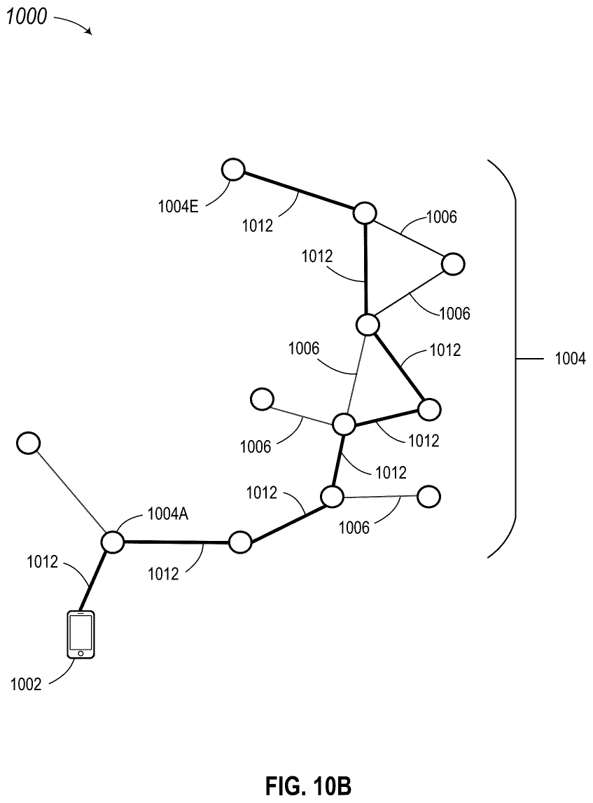

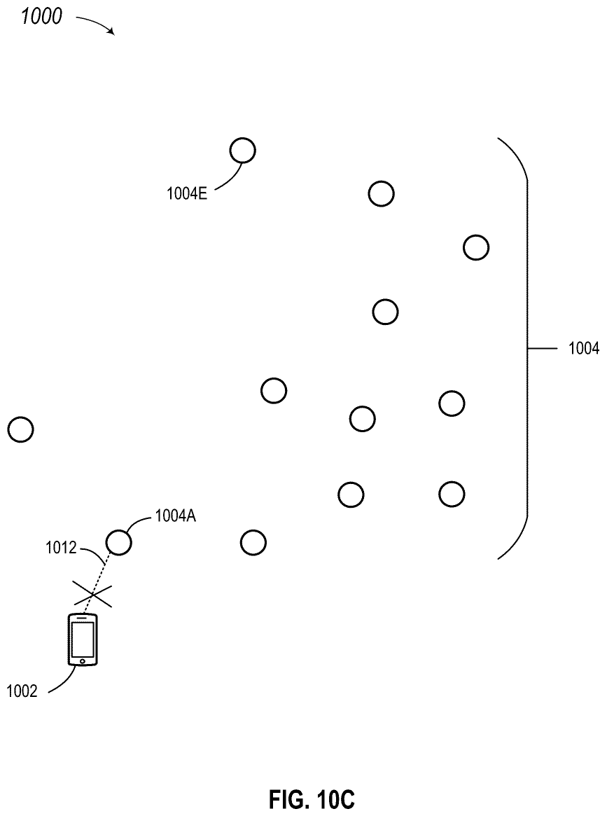

FIG. 10A illustrates an example of a typical PAN, in accordance with an embodiment of the present disclosure. In the example PAN illustrated in FIG. 10A, the nodes 1004 are represented by circles. In one possible example, the nodes may be streetlights with BLE radios and processors, as in the example mesh network of FIG. 9. In a standard BLE network, the mobile device 106 can only communicate with nodes that are within direct BLE range. In the example of streetlights, this is often only one or two nodes at one time.

In the example of FIG. 10A, the mobile device 106 first connects to node 108A via wireless connection 109A. However, in order to connect with node 106B, the device 106 must move within range of the PAN radio. This is illustrated by arrow A. Once the device 106 has moved within range of the PAN radio, it connects to node 108B via wireless connection 109B, while the connection 108A has been dropped since node 108A is now out of range. The computing device 106 cannot, however, connect to node 108C or to node 108D until it moves within range of the PAN radio, as illustrated by arrow B.

FIG. 10B illustrates an example of a mesh network, in accordance with an embodiment of the present disclosure, similar to the example mesh network of FIG. 10A above. In example mesh network of FIG. 10B, each node 1004 forms a connection 1006 with any surrounding nodes that are within the range of the PAN radio in that node. Whenever a message is sent, it is repeated across each existing connection 1006. In some PAN implementations, mechanisms are in place to avoid messages being repeated forever. Typically, nodes do not repeat messages they have already sent, and messages are only repeated a limited number of times.

With the mesh in place, the computing device 1002 can now connect to any node, such as node 1004A, and is able to communicate to any other node that is part of the mesh, such as node 1004E. The path that a message might take to get from the computing device 1002 to node 1004E is indicated by the connections 1012 highlighted in bold. It should be noted that connections 1012 are a subset of connections 1006 and are only denoted as connections 1012 to highlight one possible path a message might take to traverse the example mesh network of FIG. 10B.

In a standard mesh network, when the computing device 1002 disconnects from the node, the mesh remains active. Security keys used to encrypt mesh communications remain valid and are stored in every node, and all messages continue to be repeated and are received by every node. This represents a security risk since an attacker that can communicate with a single node can now control the entire mesh. A physical attack against a single node could allow the node to control the network or could yield the security keys to be used in another device. It is much easier to attack one node and then control an existing mesh rather than have to setup a new mesh. Mesh setup and configuration can be implemented as special commands that require special security methods before they are executed.

FIG. 10C illustrates an example of an ephemeral mesh network, in accordance with an embodiment of the present disclosure. The ephemeral mesh network requires the presence of an authorized computing device 1002 in order for the mesh to form and remain active. When the computing device 1002 connects to a node 1004A, it is first authenticated using authentication methods described herein. If the computing device 1002 is successfully authenticated, it can issue commands that launch the creation of the mesh network. The commands are propagated by all nodes 1004 so that every node within range of any connected node becomes a member of the mesh, as illustrated in FIG. 10B. New security keys are created and stored in each device each time the mesh is created. As in FIG. 10B, computing device 1002 would have a path to node 1004E.

Whenever the computing device 1002 disconnects or walks away, as indicated by the broken connection 1012 to node 1004A, the mesh network is destroyed, and as illustrated, computing device 1002 would have no remaining path to node 1004E, or any other node. The node 1004A that was previously connected to the computing device 1002 automatically sends a message instructing all nodes to tear down the mesh. Each node deletes mesh connection and configuration data, and all security keys are destroyed. Any attacker connecting to any one node would therefore only have access to that one node.

In some embodiments, limiting the size of the mesh, i.e., the number of nodes, allows for convenient access to devices where access is limited, dangerous, and/or expensive. In applications such as offices and shopping malls, limiting the size of the mesh allows for common settings updates.

In some embodiments, the mesh network provides capabilities including, but not limited to, adjusting maximum brightness, updating schedules, collecting energy usage and diagnostic data, and remote firmware updates.

In some embodiments, the mesh network allows for factory provisioning, whereby network keys, application keys, and a unicast address may be installed during manufacturing. In some embodiments, field provisioning uses the customer Public Key Infrastructure (PKI) key that was installed during manufacturing for out-of-band authentication. During the field provisioning, a device, such as a smart phone, provisions the first node, and other nodes are remotely provisioned automatically.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Any of the operations described herein may be implemented in a system that includes one or more non-transitory storage devices having stored therein, individually or in combination, instructions that when executed by circuitry perform the operations. “Circuitry”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an Integrated Circuit (IC), System-on-a-Chip (SoC), Application-Specific Integrated Circuit (ASIC), Programmable Logic Device (PLD), Digital Signal Processor (DSP), Field Programmable Gate Array (FPGA), logic gates, registers, semiconductor device, chips, microchips, chip sets, etc.

The storage device includes any type of tangible medium, for example, any type of disk including hard disks, floppy disks, optical disks, Compact Disk Read-Only Memory (CD-ROMs), Compact Disc-Rewritable (CD-RWs), and magneto-optical disks, semiconductor devices such as Read-Only Memories (ROMs), Random Access Memories (RAMs) such as dynamic and static RAMs, Erasable Programmable Read-Only Memories (EPROMs), Electrically Erasable Programmable Read-Only Memories (EEPROMs), flash memories, Solid State Disks (SSDs), including Non-Volatile Memory express (NVMe) SSDs, Embedded Multimedia Cards (eMMCs), Secure Digital Input/Output (SDIO) cards, magnetic or optical cards, or any type of media suitable for storing electronic instructions. Other embodiments may be implemented as software executed by a programmable control device. Also, it is intended that operations described herein may be distributed across a plurality of physical devices, such as processing structures at more than one different physical location.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

1. A system to control devices using wireless communications, the system comprising:
a mobile device including a wireless interface; and
a device including a controller, a wireless interface, and an LED driver communicatively coupled to the controller, the controller including circuitry configured to:
connect wirelessly to the mobile device;
receive commands from the mobile device;
send the commands from the mobile device to the LED driver;
read status from the LED driver; and
send the status from the LED driver to the mobile device.

2. The system of claim 1, wherein the wireless interface is a short-range wireless communications interface.

3. The system of claim 2, wherein the short-range wireless communications interface is a low energy communications interface.

4. The system of claim 1, wherein connect wirelessly to the mobile device further comprises circuitry configured to:
receive a security token generated by a server;
decrypt the security token; and
responsive to decrypting the security token using a proper public-key, authenticate the mobile device.

5. A system to manage non-networked devices, the system comprising:
one or more non-networked devices;
one or more software systems;
one or more mobile users using one or more mobile devices; and
an asset management platform, the asset management platform including circuitry configured to:
receive data from one or more users, one or more systems, and the one or more mobile users using one or more mobile devices;
store the data in a repository;
connect to the one or more mobile users using one or more mobile devices;
connect to the one or more non-networked devices through the one or more mobile devices;
send commands and data from the repository to the one or more non-networked devices through the one or more mobile devices;
receive device data from the one or more non-networked devices through the one or more mobile devices; and
store the device data in the repository.

6. The system of claim 5, wherein the data includes at least one of asset data, user data, customer data, and data related to an organization of assets.

7. The system of claim 5, wherein the one or more mobile users using the one or more mobile devices function as an Internet of Things (IoT) gateway.

8. The system of claim 5, wherein the asset management platform is a server.

9. The system of claim 5, wherein the repository is remote from the asset management platform.

10. A system to network devices using an ephemeral mesh network, the system comprising:
a plurality of devices, each device of the plurality of devices further comprising:
a wireless interface to communicate with a mobile device;
a controller, the controller including circuitry configured to:
connect to the mobile device;
authenticate the mobile device;
responsive to authenticating the mobile device, establishing a mesh network of the plurality of devices, wherein each device connects to at least one other device of the plurality of devices to create a mesh network; and
responsive to disconnecting from the mobile device, dissolving the mesh network by disconnecting each device from each other device of the plurality of devices.

11. The system of claim 10, wherein the wireless interface is a Bluetooth Low Energy (BLE) personal area network.

12. The system of claim 10, wherein one or more messages are passed between a plurality of nodes of the mesh network to span a distance greater than a maximum range of an underlying networking topology.

13. The system of claim 10, wherein the mesh network uses a network-to-network bridge to exceed a maximum node limitation of an underlying networking topology.

14. The system of claim 10, wherein responsive to authenticating the mobile device, establishing the mesh network of the plurality of devices, wherein each light device connects to at least one other device of the plurality of devices to create a mesh network further comprises:
create one or more security keys for the mesh network; and
store the one or more security keys for the mesh network in each node of the mesh network.

15. The system of claim 14, wherein responsive to disconnecting from the mobile device, dissolving the mesh network by disconnecting each device from the plurality of devices further comprises:
send a message to each node of the mesh network instructing each node of the mesh network to tear down the mesh network; and
destroy a mesh connection and configuration data and the one or more security keys for the mesh network from each node of the mesh network.
